(19) United States
(12) Patent Application Publication
(10) Pub. No.: US 2002/0103722 A1
(43) Pub. Date: Aug. 1, 2002

(54) Electronic recruiting station

(76) Inventor: Darrel O. Brown, Seabrook, TX (US)

Correspondence Address: Attn: Robert C. Curfiss, BRACEWELL & PATTERSON L.LP., Suite 2900, 711 Louisiana, Houston, TX, 77027-9095, US

(21) Appl. No.: 09/773,865

(22) Filed: Feb. 1, 2001

(51) Int. Cl. G06F 17/60

(52) U.S. Cl. 705/27

(57) ABSTRACT

A recruiting station for attracting potential recruits and for collecting key data from the recruits at a remote location without requiring the presence of recruiting personnel, includes an advertising display associated with the station for attracting recruits to the system, an electronic collection system for instructing the recruit and collecting key data from the recruit, and a processing system for storing the collected data in an electronic format. The system is adapted for attracting potential recruits to a placement agency by taking the agency to the recruits in their normal, everyday environment. A secure system for collecting and managing information is provided wherein a potential recruit is exposed to the solicitation of employees without interfering with his normal life and activities. In one form of the invention, a kiosk-type work center can be placed in shopping malls and the like with promotional advertising for catching the attention of passers by. The prospective recruit simply fills out an electronic form at the kiosk center and saves his information. The center is not manned, reducing the costs to the agency.

### BACKGROUND OF INVENTION

1. Field of Invention

The present invention relates generally to the field of employment staffing and placement, and more particularly to an automated device and method for providing and receiving employment staffing and placement opportunities and soliciting employment information.

2. Description of the Prior Art

It is generally acknowledged by economic analysts that the economy in the United States has shifted from the traditional manufacturing base to an economy that is driven by service industries. This shift can be attributed in large part to advancements in technology, such as the advent of the world wide web, that have resulted not only in the expansion of technical jobs, but also created entire new sectors of business. In the past, the majority of U.S. workers were employed to produce goods and commodities. However, a dwindling percentage of workers continue to be employed in the industrial sectors. More and more, workers are employed to provide services and work with information.

There has also been a shift in the type of service work available. Traditionally, service jobs were most commonly viewed as menial, low paying positions that required little education or training. In the economic revolution of the information age, the more modern service positions require more highly skilled, technologically sophisticated employees in fields such as telecommunications, and data processing. In addition, as the population continues to increase, there is a greater demand for the more traditional service positions, such as programmers, teachers, accountants, doctors, lawyers, managers, technicians and the like.

Despite this shift from a goods-producing economy to a service-producing economy, the U.S. remains one of the world's leading industrial and agricultural nations and the manufacturing sector continues to expand. As such, there still remains a need for workers to fill these positions.

However, the continued expansion of the manufacturing sector, combined with the shift to a service based economy has resulted in labor shortages. For employment recruiters, such shortages have result in increased competition in the identification and recruitment of laborers.

In addition, the trend in industry has also seen a shift to outsourcing. Outsourcing is the contracting out of a company's noncore, nonrevenue-producing activities to specialists. It differs from contracting in that outsourcing is a strategic management tool that involves the restructuring of an organization around what it does best, i.e., its core competencies.

The popularity of outsourcing continues to gain momentum in both the manufacturing and service industries. Businesses are turning to outsourcing for a wide range of functions from logistics to human resources to purchasing. Although outsourcing has more traditionally applied to contracts for “blue collar”-oriented functions such as maintenance, security, and food services, the shift in the focus of the economy has seen a large increase in the outsourcing of “white collar” type functions. Two common types of high-skill outsourcing are Information Technology (IT) outsourcing and Business Process Outsourcing (BPO). BPO includes outsourcing related to accounting, human resources, benefits, payroll, finance functions and activities.

The outsourcing trend has accelerated as U.S. organizations have endeavored to become or remain competitive in the global economy. To do so, organizations are focusing on their “core competencies.” This drive to focus on core competencies is fueled by a desire for organizations to provide better customer service while, at the same time, increasing profit margins.

Aside from focusing on core competencies, the reasons for, and benefits obtained from, improved efficiencies are many.

There are several reasons for this:

Reduce and control operating costs

Improve company focus

Gain access to world-class capabilities

Free internal resources for other purposes

Resources are not available internally

Accelerate re-engineering benefits

Function difficult to manage/out of control

Make capital funds available

Share risks

Cash infusion

Dunn & Bradstreet indicates that worldwide expenditures on outsourced activities in 2000 will grow more than 25 percent over 1999 levels. This was developed from interviews in June 1999 with more than 2,200 organizations drawn from Dunn & Bradstreet's global database of more than 57 million companies. Respondents include large and small companies, banks and institutions. Outsourcing was defined as the use of outside partners to perform tasks that traditionally would have been performed inside the company.

Historically, in the employment and staffing placement industry, the success of employment and staffing businesses has been driven by sales and relationships of such businesses with their clients. Thus, heretofore, the typical business plan of such staffing businesses was to forge relationships that led to sales.

With this continuing shift of employment philosophy it has become increasingly difficult to establish a data base of workers with specific skills to fill such jobs by agencies when a client requests support. Historically, the staffing industry has expected the recruits to come to the agency rather than taking the agency to the recruits. Occasionally, job fairs and similar activities place agencies in front of large groups of people, but even here the potential recruits have to make the effort to come to the location of the job fair. The historic methods of running advertisements on radio and television or in print ad in newspapers and trade periodicals simply do not attract a sufficient number of qualified people to keep the system operating at optimum levels. Using these historical methods, recruiting cannot keep up with demand.

### SUMMARY OF INVENTION

The subject invention is directed to a recruiting station for attracting potential recruits and for collecting key data from the recruits at a remote location without requiring the presence of recruiting personnel. The system includes an advertising display associated with the station for attracting recruits to the system, an electronic collection system for instructing the recruit and collecting key data from the recruit, and a processing system for storing the collected data in an electronic format.

The system of the subject invention provides for a method and apparatus for attracting potential recruits to a placement agency by taking the agency to the recruits in their normal, everyday environment. A friendly, secure system for collecting and managing information is provided wherein a potential recruit is exposed to the solicitation of employees without interfering with his normal life and activities. In one form of the invention, a kiosk-type work center can be placed in shopping malls and the like with attractive promotional advertising for catching the attention of passers by. The prospective recruit simply fills out an electronic form at the kiosk center and saves his information. The advantage to this arrangement is that the center is not manned, reducing the costs to the agency and also placing the recruit in a more comfortable situation as he does not have to fear that he will be subjected to an unwanted sales pitch when he enters the center.

In addition, since the system is free-standing and automated, it is possible for the advertising as well as the data collection process to be multi-lingual without the requirement of an on-site translator or multi-linguist. This makes the system less ominous to those potential recruits who may have language barriers.

The data is collected by the agency on a periodic basis by downloading the collected data from the center. Since it is already in an electronic format, the data may be immediately entered into the agency's data base and the recruit's information can be searched for placement purposes.

The system of the present invention may be a stand alone unit or may be a series of networked units wherein more than one potential recruit may access the system at the same time.

The collected data is generally stored on a medium provided at the work center on a hard drive or floppy disk or the like. It can either be manually downloaded or electronically transferred to the agency's central data base via the Internet. One advantage to the stand-alone system with manual download is that the work center may be placed anywhere without need for a telephone line, cable or other hardwired connection to the Internet, greatly increasing the flexibility of the system.

In the preferred embodiment of the system a video screen is provided for running a multimedia, multi-dimensional promotional advertisement for attracting potential recruits to the center.

In other embodiments the advertisement may be a poster-type advertisement or may be eliminated altogether. The workstation includes a keyboard and a CRT screen providing information and an electronic form for collecting the information. The recruit simple enters his information on the keyboard, reviews on the screen and saves it. The agency then collects the information and enters it in its permanent data base. The recruit's information can then be searched and the recruit can be contacted when specific job opportunities are identified by the agency.

The work center of the subject invention has been highly successful when place in shopping malls and other high-traffic areas, as well as at job fairs and the like. The work center attracts substantially more recruits than historic advertising by bringing the recruiting agency to the public rather than attempting to attract specific components of the public to the agency.

It is, therefore, an object and feature of the subject invention to provide a method and apparatus for collecting useful data from potential recruits for use by a placement agency by providing a user friendly data collection system that can be place in high-traffic areas for attracting passers by and collecting key information from them.

It is another object and feature of the subject invention to provide a method and apparatus for collecting key recruit information without requiring manpower at the point of collection.

It is a further object and feature of the subject invention to provide a method and apparatus for collecting key recruit information in an electronic format that can be merged into an agency data base without further processing.

It is also an object and feature of the subject invention to provide for on-site collection and storage of key recruit information for later downloading to the agency database.

It is an additional object and feature of the subject invention to provide a method and apparatus for collecting information in a variety of languages without requiring an on-site translator or multi-linguist.

It is yet another object and feature of the subject invention to provide for multi-media advertising in order to attract potential recruits to the display.

Other objects and features of the invention will be readily apparent from the accompanying drawings and detailed description of the preferred embodiment.

### BRIEF DESCRIPTION OF THE DRAWINGS

FIG. 1 is a front view of a stand-alone kiosk type workstation.

FIG. 2 is a side view of the kiosk type workstation of FIG. 1.

FIG. 3 is a sample of an advertisement used in connection with the work station in order to attract potential recruits.

FIG. 4 is an additional sample of an advertisement used in connection with the work station in order to attract potential recruits.

FIG. 5 is the initial registration screen.

FIGS. 6-13 are additional registration and data collection schemes.

### DESCRIPTION OF THE PREFERRED EMBODIMENT

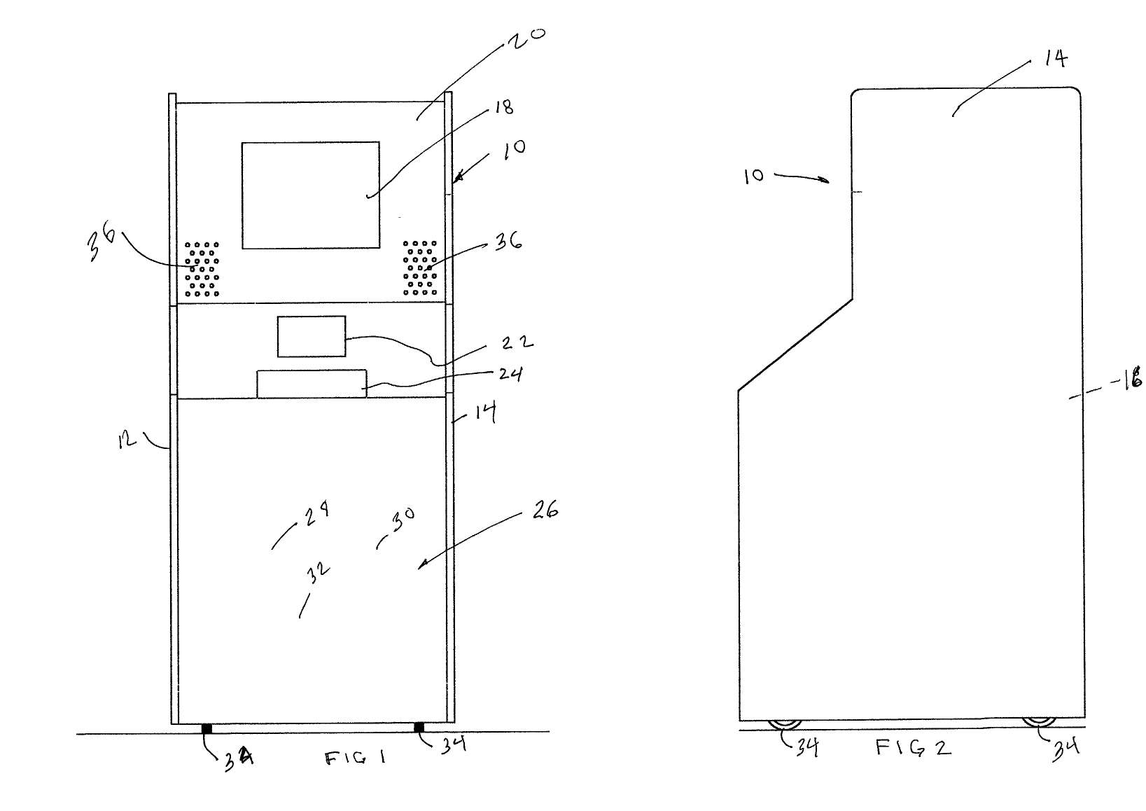

A kiosk-type system in accordance with the subject invention is shown in FIGS. 1 and 2.

Typically, the system will be housed in a cabinet 10 having sidewalls 12 and 14 and a closed back wall 16. The front of the cabinet permits a display screen 18 to be visible through a protective wall 20. A CRT screen 22 and a keyboard 24 are also provided in the front of the cabinet and accessible by the user. The lower cabinet area 26 houses the processing system, such as the personal computers 28 and 30, and the power supply, including for example, the uninterrupted power supply unit 32. In the preferred embodiment a plurality of locking rollers or casters 34 are mounted on the cabinet to facilitate portability. The system is connected to house current by standard means as is well known in the art.

It should be understood that a plurality of workstations could be used in tandem with a single display screen. It should also be understood that the display screen could be replaced by other advertising media without departing from the scope and spirit of the invention.

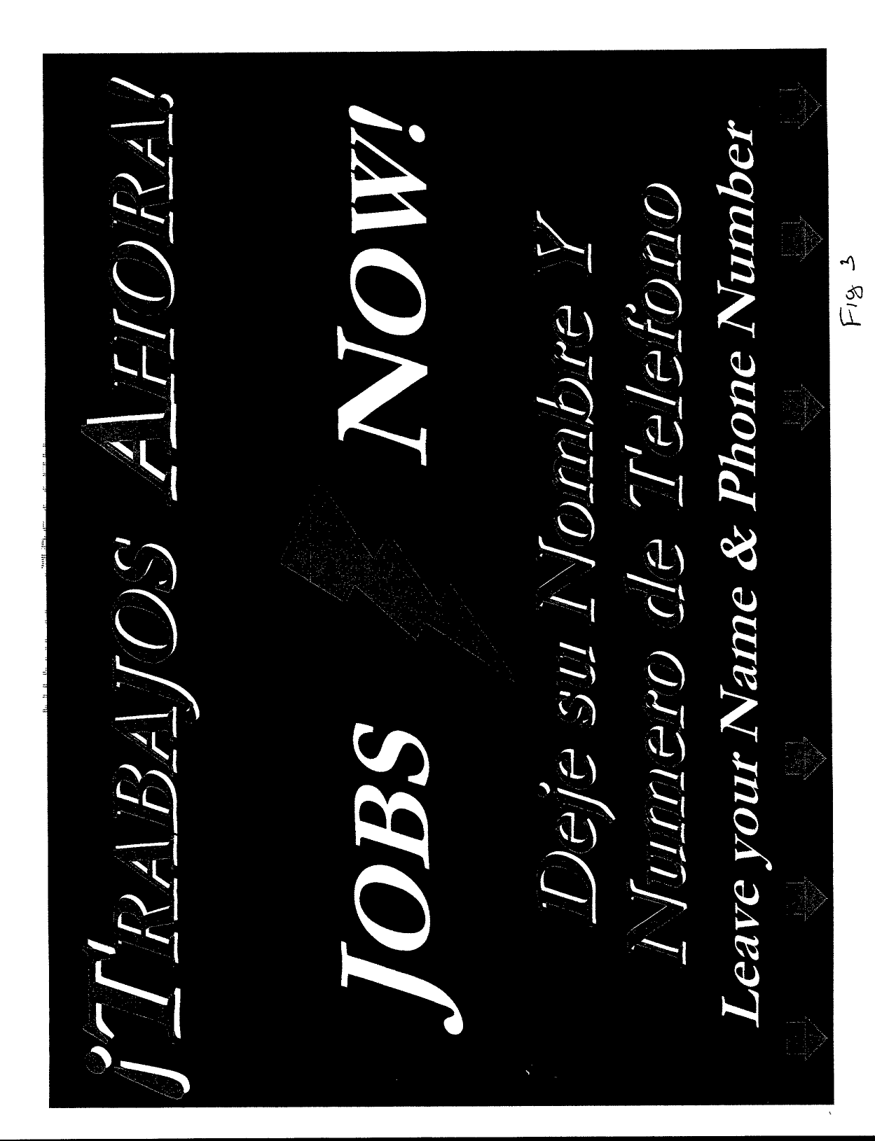

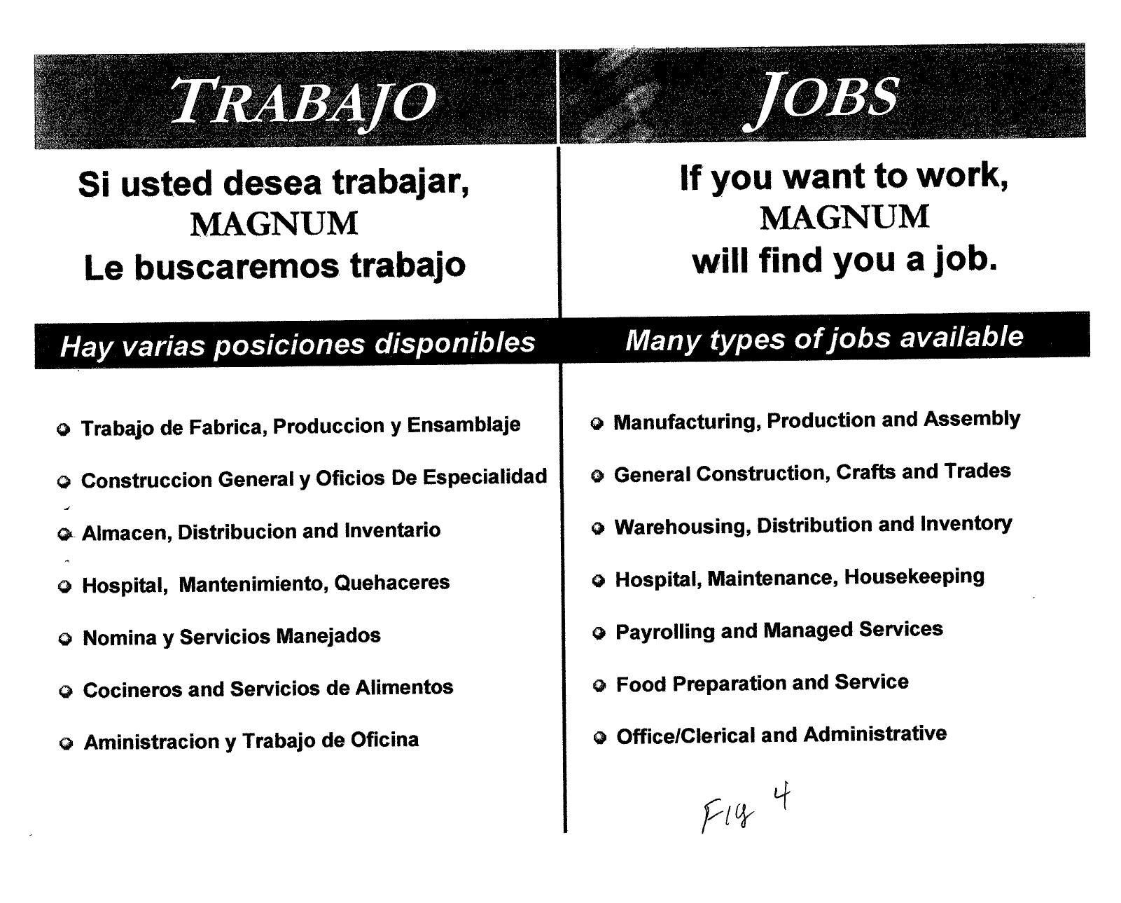

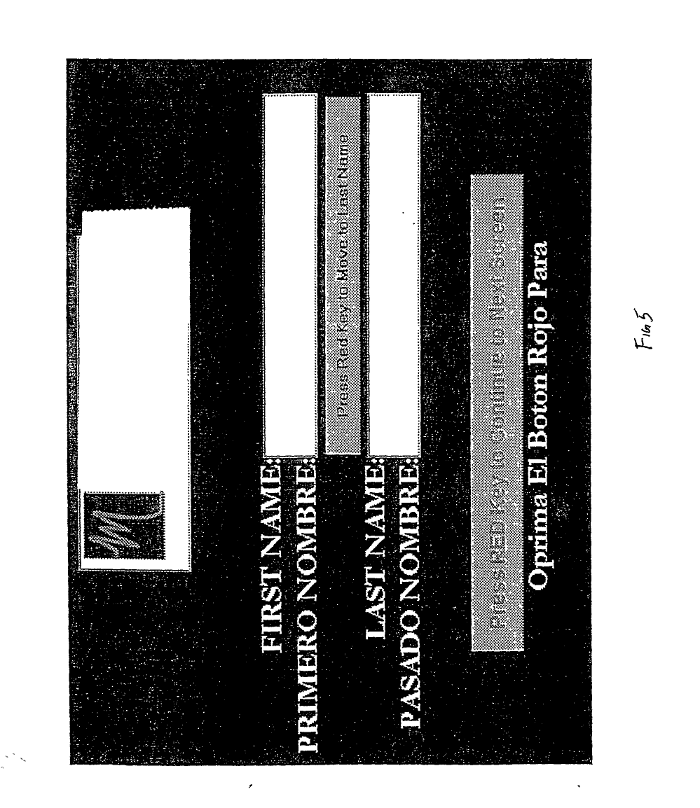

Typical advertisement panel are shown in FIGS. 3 and 4. These advertisements are provided to attract passers by to the workstation. The advertisement may be stored in electronic digital format in the processing system or may be a separate loop video tape or the like. Also, poster type advertisements may be utilized in combination with the video screen or independently of the video screen. The cabinet of FIGS. 1 and 2 is generally adapted to accommodate a speaker system, as indicated at 36, permitting full multi-media advertising.

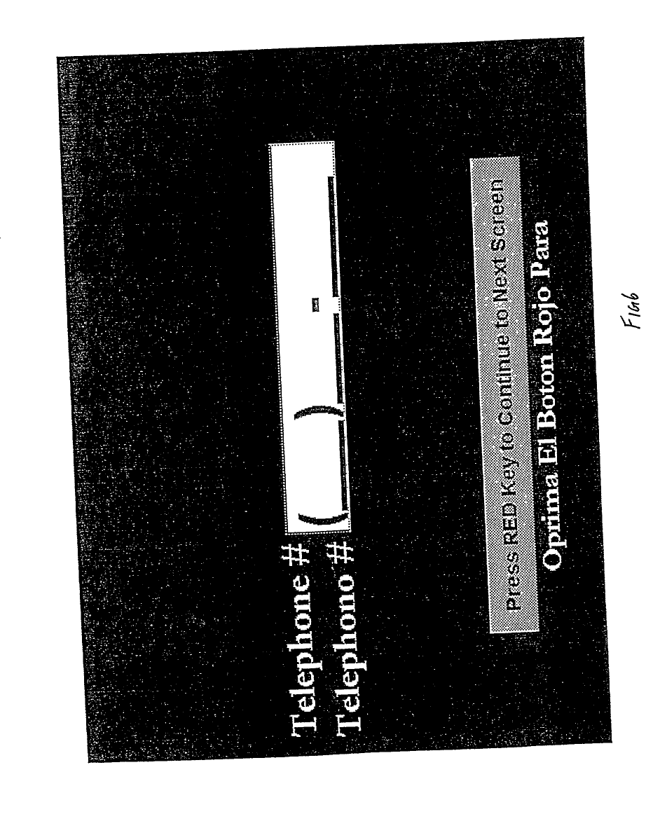

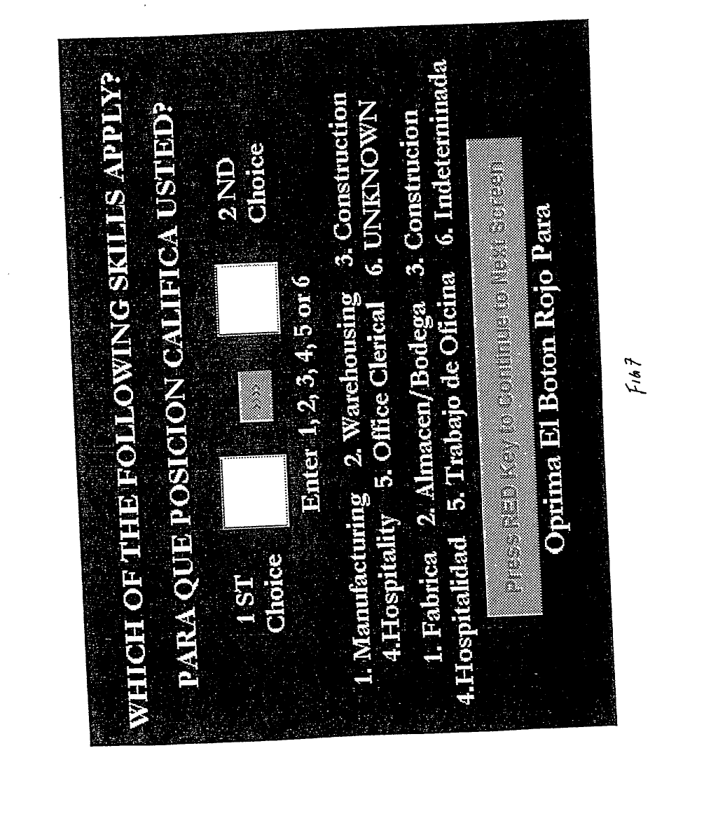

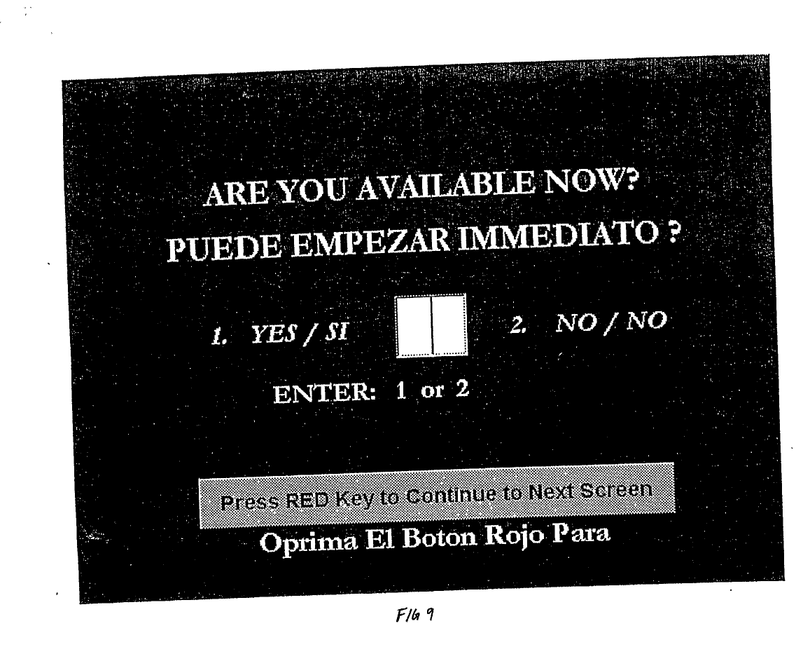

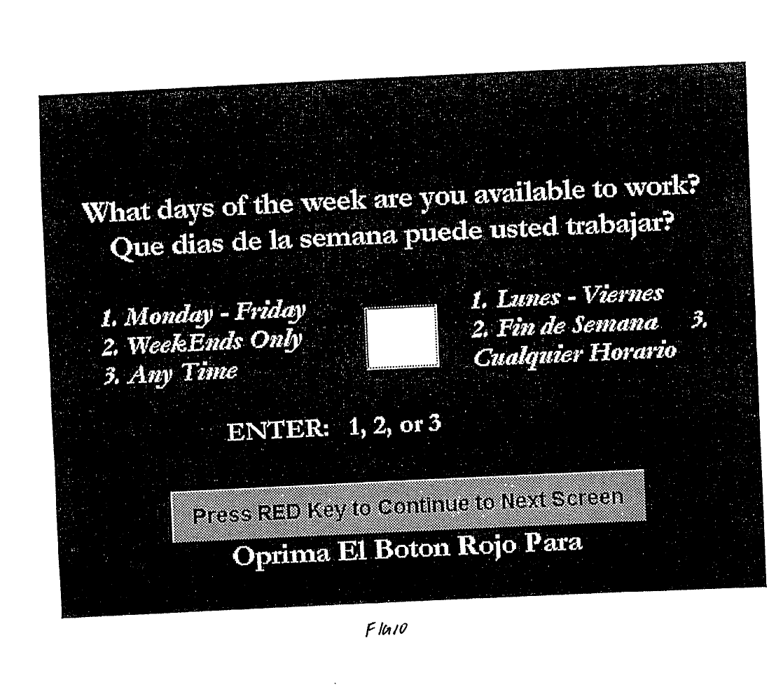

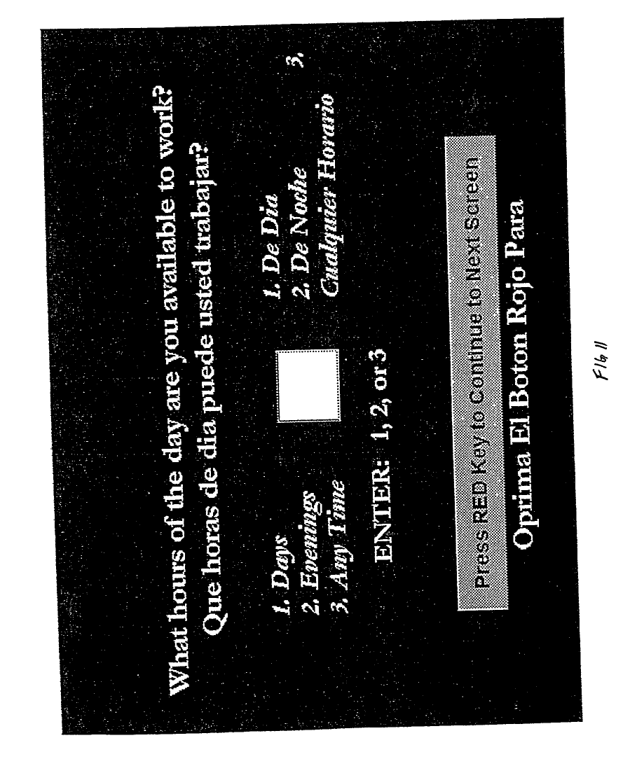

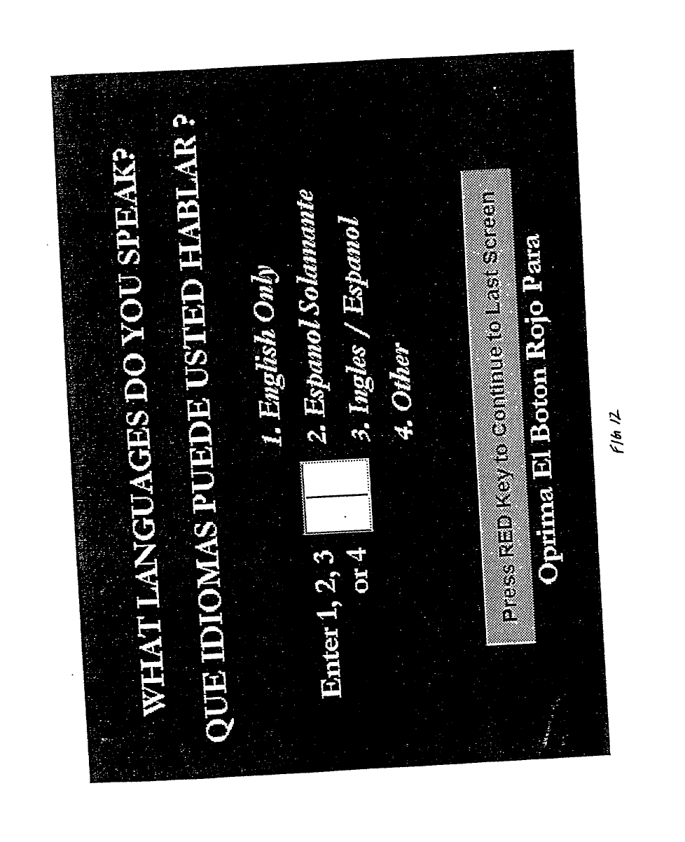

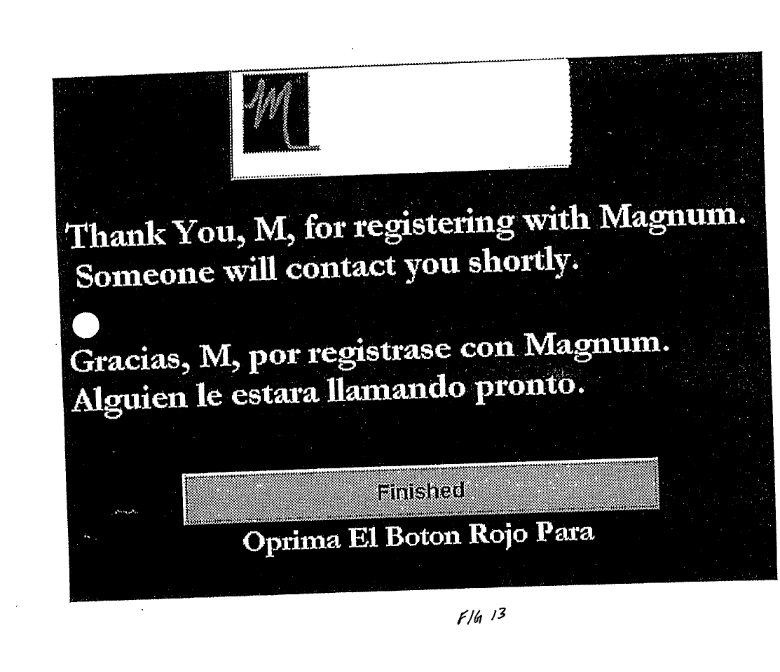

FIG. 5 is the initial registration screen presented to the viewer when he approaches the workstation. FIGS. 6-13 are samples of additional registration and data collection screens. One advantage of the system of the subject invention is the ability to advertise and collect information in any of a number of languages without requiring the presence of an on-site translator.

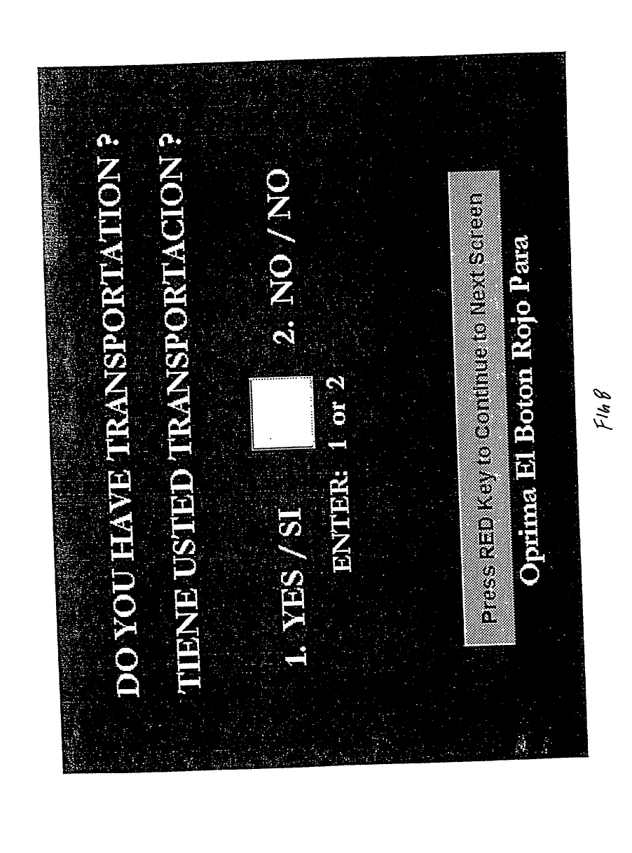

In a typical operation, the recruit will be attracted to the system by the advertising and will follow the directions on the CRT screen. He will first enter his name as indicated on the screen in FIG. 5. Once completed he will proceed to the next screen by pressing the identified key on the keyboard. The screen of FIG. 6 is used to capture the telephone number of the recruit. Specific skill, availability data and other key information about the recruit are collected in the screens of FIGS. 7-12. A sign-off screen is shown in FIG. 13. Typically, if the recruit does not sign off, or if any of the screens shown in FIGS. 6-12 are not exited, the system will return to the initial screen of FIG. 5 after a predetermined period of time.

The data is collected by the processing system and may locally stored there on a standard hard disk or a floppy drive or other medium for later downloading. Typically, in the most versatile application, the date is stored on a portable medium such as a floppy disk whereby a maintenance person may periodically remove the data and later transmit it or transport it to the agency central data base. Where desired, a link to the Internet may be provided whereby the data may be remotely downloaded from the station.

While certain features and embodiments of the invention have been described in detail herein, it will be readily understood that the invention includes all enhancements and modifications within the scope and spirit of the following claims.

1. A recruiting station for attracting potential recruits and for collecting key data from the recruits at a remote location without requiring the presence of recruiting personnel, comprising:
a. An advertising display associated with the station for attracting recruits to the system;
b. An electronic collection system for instructing the recruit and collecting key data from the recruit; and
c. A processing system for storing the collected data in an electronic format.

2. The recruiting station of claim 1, further including a free-standing cabinet for housing the advertising display, the collection system and the processing system.

3. The recruiting station of claim 1, wherein the advertising display is a multi-media display.

4. The recruiting station of claim 1, wherein the advertising display includes a video screen.

5. The recruiting station of claim 1, wherein the advertising display includes an audio system.

6. The recruiting station of claim 1, wherein the electronic collection system includes an instructional screen and a keyboard for controlling the information displayed on the instructional screen and for inputting recruit information.

7. The recruiting station of claim 1, wherein the processing system includes a subsystem for storing the collected data in an electronic format.

8. The recruiting station of claim 7, wherein the subsystem is a floppy disk.

9. The recruiting station of claim 7, wherein the subsystem is a hard drive.

10. The recruiting station of claim 7, further including means for remotely downloading the collected data via the Internet.

11. The recruiting station of claim 1, further including a plurality of electronic collection systems associated with each advertising display.

12. The recruiting station of claim 11, further including a processing system associated with each electronic collection system.

13. The recruiting station of claim 1, wherein the electronic collection system is multi-lingual.

14. The recruiting station of claim 1, wherein the advertising display is multi-lingual.
